(19) United States
(12) Patent Application Publication
(10) Pub. No.: US 2007/0139927 A1
(43) Pub. Date: Jun. 21, 2007

(54) Parametric display system for motor vehicles

(76) Inventor: Joe Delasko, Houston, TX (US)

Correspondence Address: Joe DELASKO, 15023 Chetland Place Drive, Houston, TX, 77095, US

(21) Appl. No.: 11/311,514

(22) Filed: Dec. 19, 2005

(51) Int. Cl. B60Q 1/00

(52) U.S. Cl. 362/276; 362/464; 362/231

(57) ABSTRACT

A parametric display system for use in the display of various motor vehicle parameters, including engine rotational speed, vehicle velocity, vehicle acceleration or engine fault conditions. The display system includes an array of indicator segments that are illuminated either individually or in groups as an indication of the quantity intended to be displayed. These illuminated segments may be multicolored. The display system may be mounted in such a way as to be viewable from outside the vehicle.

### BACKGROUND

The effectiveness of any exterior lighting system is dependent on its specificity of purpose, how readily it conveys useful information, and how conspicuous it is to outside observers. Both of which may be improved by selective application of unusual lighting in key areas of the vehicle.

A multitude of systems currently exist which relay a wide variety of key vehicle information to that vehicle's operator. However, systems are currently unavailable which relay key vehicle information to another vehicle's operator or to pedestrians. The extravehicular information that is available to outside observers is currently limited to the application of brake lights, turn signals, backup lights, warning flashers, and parking lights.

When Dale Earnhardt Sr. lost his life in the Daytona 500, in February 2001, this incident drew national attention to the dangers of auto racing. Many discussions about safety issues were heard during subsequent race telecasts. One topic that came up frequently was the addition of a brake light to the back of the race cars so drivers would have more time to react to a vehicle suddenly slowing down in front of them. The brake light idea was quickly dismissed since it was believed that such a light would be used as a driving strategy, at least for a short while. If drivers started tapping the brake light in an attempt to get a driver to the rear to back off, then all drivers would be quickly conditioned to ignore the brake lamp.

Similar concerns are recognized in the ordinary traffic that is encountered every day, in every city around the world. If pedestrians and operators of other vehicles better understood what the driver of any given vehicle was currently doing or about to do, they would be better able to react accordingly in a safe and predictable manner.

There is clearly a need in society for an improved display system, which is viewable and conspicuous from outside of the vehicle, to provide a visual indication to another vehicle's operator, in order to allow them to more fully and more quickly understand and react to changes in the vehicle operation or condition in such a way as to improve everyone's safety. The present invention is directed to the problems set forth above. Accordingly, what is desired is a selective external display of key motor vehicle operating parameters, such as brake and accelerator information, which are conspicuous to those interacting with the vehicle.

### SUMMARY

In one aspect of the present invention, a parametric presentation system for use in motor vehicles is provided. This parametric system includes a display means that is mounted on the motor vehicle in such a way as to be viewable from outside the motor vehicle. This display means presents a plurality of motor vehicle parameters.

In another aspect of the present invention, a parametric display system for use in motor vehicles is provided. This parametric display system includes a plurality of illuminated segments, which are mounted to the motor vehicle in such a way as to be viewable from outside of this motor vehicle. A means for providing a signal to these illuminated segments is included. This signal means causes the illuminated segments to be lighted in a controlled and meaningful way. An input signal is provided to the signal means, which is generated by either a variance of at least one vehicular parameter, the occurrence of at least once vehicular function, or both.

In another aspect of the present invention, an apparatus including a plurality of progressively illuminated segments is provided. The illuminated segments are mounted on a vehicle in such a way as to be viewable form outside said vehicle.

In another aspect of the present invention, the apparatus includes a signal means for providing a signal to the illuminated segments. The signal means causes the illuminated segments to be lighted in a controlled and meaningful way.

In yet another aspect of the present invention, an input is provided to the signal means, which is generated by the variance in at least one vehicular parameter.

In yet another aspect of the present invention, an input is provided to the signal means, which is generated upon the occurrence of at least one vehicular function.

In yet another aspect of the present invention, a method of displaying motor vehicle parameters is provided. This method includes a providing a plurality of illuminated segments, which are mounted to the motor vehicle in such a way as to be viewable from outside of this motor vehicle. A means for providing a signal to these illuminated segments is also provided. This signal means causes the illuminated segments to be lighted in a controlled and meaningful way. An input signal is provided to the signal means, which is generated by either a variance of at least one vehicular parameter, the occurrence of at least once vehicular function, or both.

### DESCRIPTION OF THE DRAWINGS

The invention may be understood by reference to the following description taken in conjunction with the accompanying drawings, and in which:

FIG. 1 is an idealized representation of one embodiment of the present invention.

FIG. 2 is an idealized representation of another embodiment of the present invention.

### DESCRIPTION

It is widely known that changes in color of an optical display are easy for humans to perceive, even at great distances. A typical example of this is the common traffic light.

This invention incorporates these physiological and psychophysical principles by having the progressively illuminated segments sequence through a multitude of colors, and each individual color segment, or plurality of same color segments, having equivalent luminance. This assures that pedestrians, or operator of other vehicles, will have the greatest opportunity to quickly process the vehicle parametric information, and react to it.

An apparatus, method, parametric presentation system, and/or parametric display system according to the invention comprises a display means that is mounted to a motor vehicle in such a way as to be viewable from outside of the motor vehicle. The parametric display may be mounted on the interior of motor vehicles near the upper rear window. Alternatively, the parametric display may be mounted on the interior or exterior of the front window, front or rear bumpers, roof, spoilers or side windows of the motor vehicle. One skilled in the art will recognize that any conspicuous mounting place that allows pedestrians and the operators of other motor vehicles to more fully and more quickly understand and react to the measured parameters in a way that promotes safety is proper.

In one embodiment, this display means is a plurality of illuminated segments. These illuminated segments may be in a predominantly horizontal orientation, a predominantly vertical orientation or a predominantly circular orientation. One skilled in the art will recognize that other orientations are also possible, which will yield a conspicuous, easily and quickly understood display.

There may be a multitude of individually illuminated segments. In one embodiment, these illuminated segments may be light emitting diodes (LED), however any other type of illuminated segments that are known in the art may be used. In an embodiment, there are sixteen individually illuminated segments. These individually illuminated segments may be capable of being illuminated in groups or individually. In another embodiment, there a multiple illuminated segments per information group, thus allowing for multiple redundancy should one or more illuminated element fail. These illuminated segments may be multicolored. These multicolored segments may be red, yellow, green and blue. In one embodiment, there are four red segments, four yellow segments, four green segments and four blue segments, although other colors may be used.

The signal that is displayed by the apparatus, method, parametric presentation system, and/or parametric display system according to the invention is provided by a signal means. A non-exhaustive list of examples of such signal means would include the engine tachometer, the vehicle speedometer, the transmission, any rotating component on the vehicle, or any other user-defined sensor. These user-defined sensors may include, but are not limited to, any physical, mechanical, electrical, or electronic quantity or parameter that correlates to a meaningful vehicular parameter or vehicular function.

Vehicular functions that may be sources of input to these user defined sensors may include, but are not limited to, engine rotational speed, instantaneous velocity of the vehicle, instantaneous acceleration or deceleration of the vehicle, a stopped or stalled engine, the occurrence of an engine fault condition, an indication that the brakes are being applied, an indication that the accelerator is being applied, an indication of the magnitude to which the accelerator is being applied, and any external stresses that are being applied to the vehicle. These external stresses may include, but are not limited to, shock and/or centrifugal force.

In another embodiment, the present invention provides a multi-color display to convey engine RPM to pedestrians and drivers within visual range. As soon as a motor vehicle's driver decreases the pedal application to the engine throttle, the parametric display will provide an instantaneous indication of a drop in engine RPM and other drivers would know instantly that a vehicle is about to slow down. If this parametric display provides drivers with merely an additional 2 tenths of a second to react to a dangerous situation, it may very well be enough to save a life, especially when considering the fact that at racing speeds, the length of a football field passes in about one second. If a brake light is combined with a display such as this, the brake light can no longer be used as a driving strategy to get drivers to back off. If a driver taps the brake light and no drop in RPM is indicated by the display, then other drivers are not fooled.

In another embodiment, the present invention provides a multi-color display to convey vehicle speed to pedestrians and drivers within visual range. As soon as the motor vehicle's driver varies the speed at which the vehicle is traveling, the parametric display will provide an instantaneous indication of the change in speed and other drivers will know instantly that the vehicle is slowing down or speeding up. At a glance, the speed of the vehicle could be determined within 10 miles per hour (MPH). By the way that the lights were sequencing, it could be determined whether the vehicle speed is essentially constant, decreasing or increasing.

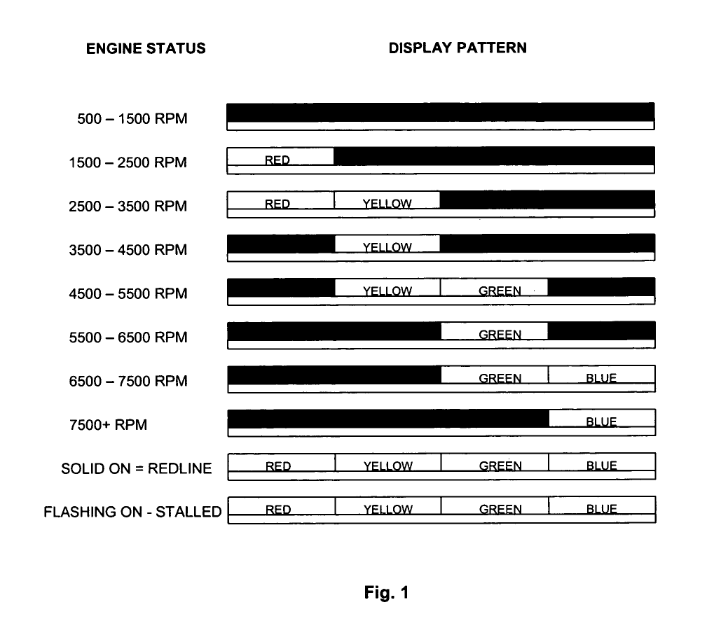

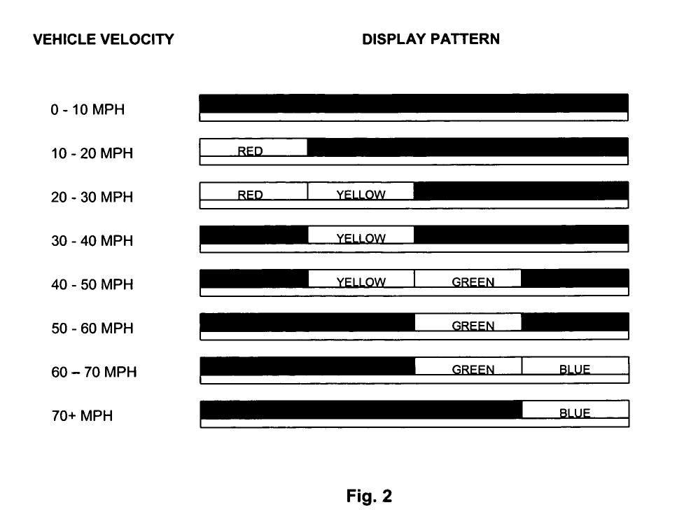

Referring to FIGS. 1 and 2, we see illustrative representations of two embodiments. In these particular examples, the parametric displays consist of four sets of colored segments. In this example, the red set of colored segments represents the low end of the range, the yellow colored segments represent the second lowest end of the range, the green colored segments represent the second highest end of the range, and the blue colored segments represent the highest end of the range. It is anticipated that more, or less, than four sets of colored segments may be desired, depending upon the parameter to be displayed.

In FIG. 1, we see that the signal means is the engine tachometer, and the parameter to be displayed is the engine rotational speed in Revolutions Per Minute (RPM). FIG. 1 also illustrates an alternate display system, wherein an illuminated band that traverses the entire display may be used to convey a secondary parameter, in this case a solid bar across the bottom might be the rear brake lamp indicator.

In FIG. 2, we see that the signal means is the vehicle speedometer, and the parameter to be displayed is the instantaneous vehicular velocity in MPH, although other units of velocity may also be used. FIG. 2 also illustrates an alternate display system, wherein an illuminated band that traverses the entire display may be used to convey a secondary parameter, in this case a solid bar across the bottom might be the rear brake lamp indicator.

As the engine RPM, or vehicle MPH, increase, the colored segments are progressively illuminated from left to right. These colored segments may also be progressively illuminated from right to left, from up to down, from down to up, or in any other fashion that clearly and quickly imparts the intended information to the operator of the other vehicle. It is intended that this useful information may be perceived and comprehended by the operator of the other vehicle at a glance, thereby enabling this person to react accordingly, thereby enhancing safety. By observing the variability of the colored light segments, it may be possible to predict the intentions of the driver of the motor vehicle.

In the example shown in FIG. 2, if these parametric displays are visible from both the front and the rear of the motor vehicle, operators of other vehicles, or pedestrians, would have access to very useful and potentially life saving information that would otherwise be unavailable to them. This display may also provide visual evidence of a vehicle exceeding local speed limits without the use of expensive and sophisticated equipment such as police radar. For example, if a vehicle equipped with such a parametric display system were to be exceeding the posted speed limit in a residential neighborhood, a resident may take a digital or conventional photograph, or video as evidence of this speeding.

As an indication of the usefulness of the present invention, one could instantly recognize that should the yellow segment be displayed, as the vehicle travels through a school zone, the vehicle would be exceeding the posted speed limit. Likewise, if the yellow and green segments were displayed as the vehicle were traveling through a typical residential neighborhood, the vehicle would immediately be recognized s exceeding the posted speed limit. If the blue segment were illuminated, one would recognize that the vehicle would be exceeding the posted speed in a 55 mile per hour zone.

From FIGS. 1 and 2, it will be obvious that the inventive parametric display system will yield conspicuous, easily read, and quickly interpreted information to drivers in other vehicles, thereby promoting safety.

Illustrative embodiments of the invention are described above. While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed, but on the contrary, the intention is to cover all modifications, equivalents, and alternatives falling within the spirit and scope of the invention as defined by the appended claims.

It will, of course, be appreciated that in the development of any such actual embodiment, numerous implementation-specific decisions must be made to achieve the developer's specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

What is claimed is:

1. An apparatus comprising: a plurality of progressively illuminated segments, wherein said illuminated segments are mounted on a vehicle in such a way as to be viewable from outside said vehicle.

2. The apparatus of claim 1, further comprising a means for providing a signal to said illuminated segments, wherein said signal means causes the controlled lighting of said illuminated segments.

3. The apparatus of claim 2, wherein an input to said signal means is generated by the variance of at least on vehicular parameter.

4. The apparatus of claim 2, wherein an input to said signal means is generated upon the occurrence of at least one vehicular function.

5. A parametric display system for use in motor vehicles comprising:
a) a plurality of illuminated segments, wherein said segments are mounted to said motor vehicle in such a way as to be viewable from outside said motor vehicle; and
b) a means for providing a signal to said illuminated segments, wherein said signal means causes the controlled lighting of said illuminated segments, and, wherein an input to said signal means is generated by one or more of:
i) the variance of at least one vehicular parameter; and
ii) the occurrence of at least one vehicular function.

6. The apparatus of claim 5, wherein said illuminated segments are arranged in a predominantly horizontal orientation.

7. The apparatus of claim 5, wherein said illuminated segments are arranged in a predominantly vertical orientation.

8. The apparatus of claim 5, wherein said illuminated segments are capable of individual illumination.

9. The apparatus of claim 8, wherein said illuminated segments further comprise sixteen individually illuminated segments.

10. The apparatus of claim 9, wherein said illuminated segments comprise four red segments, four yellow segments, four green segments, and four blue segments.

11. The apparatus of claim 5, wherein said illuminated segments are capable of being illuminated in groups.

12. The apparatus of claim 5, wherein said illuminated segments are multi-colored.

13. The apparatus of claim 10, wherein the colors of said illuminated segments are selected from the group consisting of red, yellow, green and blue.

14. The apparatus of claim 5, wherein said illuminated segments are mounted near the upper rear window of the vehicle.

15. The apparatus of claim 5, wherein said illuminated segments are mounted at a location selected from the group consisting of the interior of a front window, the exterior of a front window, the front bumper, the rear bumper, the roof, and a spoiler.

16. The apparatus of claim 5, wherein said signal means is selected from the group consisting of the engine tachometer, the speedometer, the transmission, any rotating component, or any user defined sensor.

17. The apparatus of claim 16, wherein said user defined sensor measures a physical, mechanical or electrical quantity.

18. The apparatus of claim 5, wherein said vehicular function is selected from the group consisting of engine rotational speed, instantaneous velocity of said vehicle, instantaneous acceleration of said vehicle, a stopped engine, the occurrence of an engine fault condition, an indication that brakes are being applied, an indication of the magnitude to which the brakes are being applied, an indication that the accelerator is being applied, an indication of the magnitude to which the accelerator is being applied, and external stresses on said vehicle.

19. The apparatus of claim 18, wherein said external stresses are selected from the group consisting of shock and centrifugal force.

20. A method of displaying motor vehicle parameters comprising:
a) providing a plurality of progressively illuminated segments;
b) mounting said illuminated segments on a vehicle in such a way as to be viewable from outside said vehicle;
c) providing a signal means, wherein said signal means causes the controlled lighting of said illuminated segments; and
d) providing an input to said signal means, wherein an input to said signal means is generated by one or more of:
ii) the variance of at least one vehicular parameter; and
ii) the occurrence of at least one vehicular function.
